(19) United States
(12) Patent Application Publication
(10) Pub. No.: US 2005/0207416 A1
(43) Pub. Date: Sep. 22, 2005

(54) Apparatus and method for deploying efficient broadcast multicast services in a wireless network

(75) Inventor: Purva R. Rajkotia, Plano, TX (US)

Correspondence Address: DOCKET CLERK, P.O. DRAWER 800889, DALLAS, TX, 75380, US

(73) Assignee: SAMSUNG ELECTRONICS Co. , LTD., Suwon-City (KR)

(21) Appl. No.: 10/896,370

(22) Filed: Jul. 21, 2004

Related U.S. Application Data
(60) Provisional application No. 60/553,651, filed on Mar. 16, 2004.

(51) Int. Cl. H04B 7/216; H04L 12/56

(52) U.S. Cl. 370/390; 370/432; 370/395.2

(57) ABSTRACT

A message transmitted from a mobile station to a base station in a wireless network providing broadcast multicast services includes a quality of service feature associated with multicast data transmissions broadcast from the base station to a plurality of mobile stations to provide real-time feedback to the base station and allow the mobile station to release or reject the broadcast multicast service.

### CROSS-REFERENCE TO RELATED APPLICATION AND CLAIM OF PRIORITY

The present invention is related to that disclosed in U.S. Provisional Patent Application Ser. No. 60/553,651, filed Mar. 16, 2004, entitled “Apparatus and Method for Deploying Efficient BCMCS Services in a Wireless Network”. U.S. Provisional Patent Application Ser. No. 60/553,651 is assigned to the assignee of the present application. The subject matter disclosed in U.S. Provisional Patent Application Ser. No. 60/553,651 is hereby incorporated by reference into the present disclosure as if fully set forth herein. The present invention hereby claims priority under 35 U.S.C. §119(e) to U.S. Provisional Patent Application Ser. No. 60/553,651.

### TECHNICAL FIELD OF THE INVENTION

The present invention relates generally to wireless networks and, more specifically, to an apparatus and method for deploying broadcast multicast services (BCMCS) in a wireless network.

### BACKGROUND OF THE INVENTION

Early code division multiple access (CDMA) networks, such as IS-95 networks, carried only a very small amount of data traffic. However, third generation wireless networks, such as IS-2000 (also called CDMA2000), are designed to carry much heavier loads of data traffic. IS-2000 networks are capable of efficiently providing both high-speed data services and voice traffic. Still other networks, such as 1×EV-DO networks, are primarily data systems. These types of networks, if used for both voice and data, typically carry voice on an adjacent channel to data traffic. However, IS-2000 networks (i.e., Release C of CDMA2000) carry voice and data on the same carrier.

BCMCS (Broadcast Multicast Service) is one type of new data service that wireless providers are implementing in third generation wireless networks, including IS-2000 networks. The BCMCS is expected to become a very prominent feature for the next release of wireless standards. In a multicast data broadcast, the same data content (e.g., sports scores, weather reports, news, and the like) is transmitted to all (or at least a plurality) of the wireless terminals (or mobile stations) in the coverage area of a wireless network base station. The BCMCS allows optimization of the use of the IS-2000 radio interface for delivery of BCMCS data transmissions to one or more mobile stations in one or more regions of an operator's network.

A user can discover the BCMCS services provided by the serving network in a variety of ways, including receiving the information on the overhead channel (e.g., BSPM—Broadcast Service Parameters Message) from the network. The network operator can control each multicast data transmission with regard to accounting aspects, regions of the network where the multicast data transmissions are available to various users and the encryption of the multicast data transmissions to protect against unauthorized reception.

However, in the current BCMCS system design, if the quality of the multicast data transmission received by a particular mobile station (MS) is poor, there is no technique allowing the mobile station (MS) to release or reject the services being offered or served. For example, the reason for rejecting the service could be improper reception or disruption in continuous services. If network operators are notified of such quality of service (QoS) problems, the network operators can use the information to properly configure the network. The current BCMCS system design does not allow the network operators to receive feedback on demand from users based on the nature of the services.

Therefore, there is a need in the art for improved systems and methods of deploying BCMCS in a wireless network. In particular, there is a need for a feedback mechanism for QoS purposes. In addition, there is a need for a technique allowing the MS to release or reject the BCMCS.

### SUMMARY OF THE INVENTION

The present invention introduces a message transmitted from a mobile station to a base station that notifies the base station of either the release or rejection of a particular content flow of a multicast data transmission. The message further includes a reason for the release or rejection of the content flow. For example, the reason could be poor or no audio reception and/or poor or no video reception by the mobile station of the content flow. The base station uses the information to optimize the transmission of multicast data to the mobile stations in the network.

To address the above-discussed deficiencies of the prior art, it is a primary object of the present invention to provide, for use in a wireless network, a mobile station capable of receiving multicast data transmissions broadcast in a coverage area of the base station. According to an advantageous embodiment of the present invention, the mobile station comprises: (i) a user interface capable of receiving input from a user of the mobile station, the input indicating a quality of service feature associated with the multicast data transmissions; (ii) a processor capable of receiving the input from the user interface and constructing a message including the quality of service feature; and (iii) a transceiver capable of receiving the multicast data transmissions and transmitting the message to the base station.

According to one embodiment of the present invention, the message is a special purpose message.

According to another embodiment of the present invention, the message is an order message, and the quality of service feature is included in a broadcast multicast service reason field of the order message.

According to still another embodiment of the present invention, the order message can further include a broadcast multicast flow field identifying a particular content flow of the multicast data transmissions.

According to yet another embodiment of the present invention, the order message can further include a broadcast multicast service session continue field indicating whether the mobile station wants to continue to receive the particular content flow.

According to a further advantageous embodiment of the present invention, a base station capable of broadcasting multicast data transmissions to a plurality of mobile stations comprises: (i) a transceiver capable of broadcasting the multicast data transmissions and receiving a message from a select one of the plurality of mobile stations, the message including a quality of service feature associated with the multicast data transmissions; and (ii) a controller capable of optimizing the multicast data transmissions based on the quality of service feature.

According to still another embodiment of the present invention, the base station is further capable of transmitting mobile station-specific information to a first target mobile station by transmitting in the broadcast data a first packet data unit containing a first address identifier associated with the first target mobile station.

According to a still further embodiment of the present invention, the message is received during field testing of the base station.

According to yet a further embodiment of the present invention, the base station is capable of modifying the power of the multicast data transmissions to optimize the multicast data transmissions.

According to an additional embodiment of the present invention, the base station is capable of modifying the multiplexing of the multicast data transmissions to optimize the multicast data transmissions.

According to a still additional embodiment of the present invention, the base station is capable of forwarding the quality of service feature to a content provider of the multicast data transmissions to optimize the multicast data transmissions.

According to a yet additional embodiment of the present invention, the base station is capable of adding error correcting coding to the multicast data transmissions to optimize the multicast data transmissions.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, in which like reference numerals represent like parts:

FIG. 1 illustrates an exemplary wireless network that deploys broadcast-multicast services (BCMCS) in an efficient manner according to the principles of the present invention;

FIG. 2 illustrates multicast data transmissions to a plurality of mobile stations in the wireless network in FIG. 1 according to one embodiment of the present invention;

FIG. 3 illustrates in greater detail an exemplary mobile station according to one embodiment of the present invention;

FIG. 4 illustrates in greater detail an exemplary base station according to one embodiment of the present invention;

FIG. 5 illustrates an exemplary order message according to one embodiment of the present invention;

FIG. 6 illustrates exemplary values of the BCMCS Reason field according to one embodiment of the present invention; and

FIG. 7 is a flow diagram illustrating a BCMCS feedback operation in the wireless network according to the principles of the present invention.

### DETAILED DESCRIPTION OF THE INVENTION

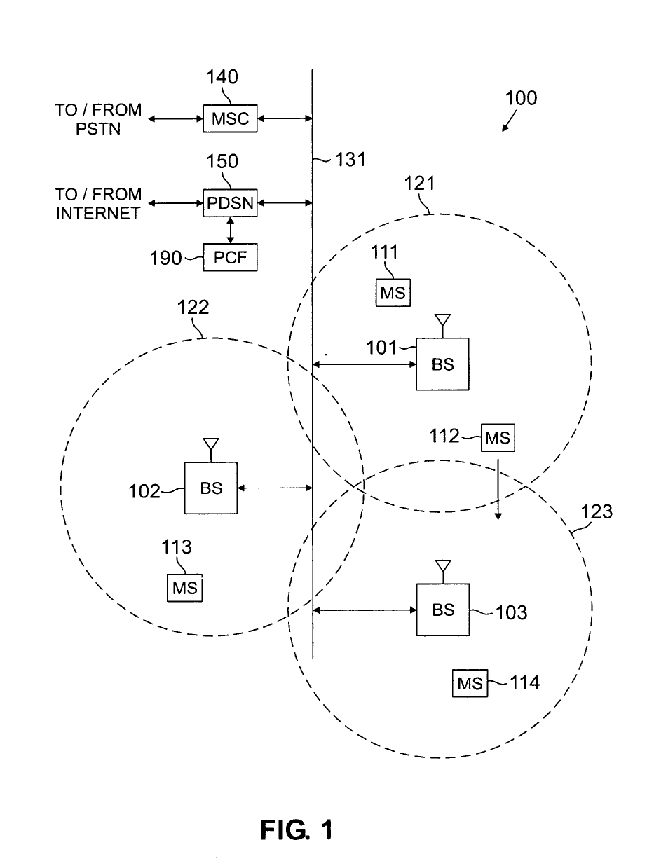

FIGS. 1 through 7, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged wireless network.

FIG. 1 illustrates exemplary wireless network 100, which deploys broadcast-multicast services (BCMCS) in an efficient manner according to the principles of the present invention. Wireless network 100 comprises a plurality of cell sites 121-123, each containing one of the base stations, BS 101, BS 102, or BS 103. Base stations 101-103 communicate with a plurality of mobile stations (MS) 111-114 over code division multiple access (CDMA) channels according to the IS-2000-C standard (i.e., Release C of cdma2000) Mobile stations 111-114 may be any suitable wireless devices, including conventional cellular radiotelephones, PCS handset devices, personal digital assistants, portable computers, telemetry devices, and the like, which are capable of communicating with the base stations via wireless links.

The present invention is not limited to mobile devices. Other types of wireless access terminals, including fixed wireless terminals, may be used. For the sake of simplicity, only mobile stations are shown and discussed hereafter. However, it should be understood that the use of the term “mobile station” in the claims and in the description below is intended to encompass both truly mobile devices (e.g., cell phones, wireless laptops) and stationary wireless terminals (e.g., monitoring devices with wireless capability).

Dotted lines show the approximate boundaries of the cell sites 121-123 in which base stations 101-103 are located. The cell sites are shown approximately circular for the purposes of illustration and explanation only. It should be clearly understood that the cell sites may have other irregular shapes, depending on the cell configuration selected and natural and man-made obstructions.

As is well known in the art, cell sites 121-123 are comprised of a plurality of sectors (not shown), where a directional antenna coupled to the base station illuminates each sector. The embodiment of FIG. 1 illustrates the base station in the center of the cell. Alternate embodiments position the directional antennas in corners of the sectors. The system of the present invention is not limited to any particular cell site configuration.

In one embodiment of the present invention, BS 101, BS 102, and BS 103 comprise a base station controller (BSC) and at least one base transceiver subsystem (BTS). Base station controllers and base transceiver subsystems are well known to those skilled in the art. A base station controller is a device that manages wireless communications resources, including the base transceiver subsystems, for specified cells within a wireless communications network. A base transceiver subsystem comprises the RF transceivers, antennas, and other electrical equipment located in each cell site. This equipment may include air conditioning units, heating units, electrical supplies, telephone line interfaces and RF transmitters and RF receivers. For the purpose of simplicity and clarity in explaining the operation of the present invention, the base transceiver subsystem in each of cells 121, 122 and 123 and the base station controller associated with each base transceiver subsystem are collectively represented by BS 101, BS 102 and BS 103, respectively.

BS 101, BS 102 and BS 103 transfer voice and data signals between each other and the public switched telephone network (PSTN) (not shown) via communication line 131 and mobile switching center (MSC) 140. BS 101, BS 102 and BS 103 also transfer data signals, such as packet data, with the Internet (not shown) via communication line 131 and packet data server node (PDSN) 150. Packet control function (PCF) unit 190 controls the flow of data packets between base stations 101-103 and PDSN 150. PCF unit 190 may be implemented as part of PDSN 150, as part of base stations 101-103, or as a stand-alone device that communicates with PDSN 150, as shown in FIG. 1. Line 131 also provides the connection path to transfer control signals between MSC 140 and BS 101, BS 102 and BS 103 used to establish connections for voice and data circuits between MSC 140 and BS 101, BS 102 and BS 103.

Communication line 131 may be any suitable connection means, including a T1 line, a T3 line, a fiber optic link, or any other type of data connection. The connections on line 131 may transmit analog voice signals or digital voice signals in pulse code modulated (PCM) format, Internet Protocol (IP) format, asynchronous transfer mode (ATM) format, or the like. According to an advantageous embodiment of the present invention, line 131 also provides an Internet Protocol (IP) connection that transfers data packets between the base stations of wireless network 100, including BS 101, BS 102 and BS 103. Thus, line 131 comprises a local area network (LAN) that provides direct IP connections between base stations without using PDSN 150.

MSC 140 is a switching device that provides services and coordination between the subscribers in a wireless network and external networks, such as the PSTN or Internet. MSC 140 is well known to those skilled in the art. In some embodiments of the present invention, communications line 131 may be several different data links where each data link couples one of BS 101, BS 102 or BS 103 to MSC 140.

In the embodiment of wireless network 100 shown in FIG. 1, MS 111 and MS 112 are located in cell site 121 and communicate with BS 101. MS 113 is located in cell site 122 and communicates with BS 102 and MS 114 is located in cell site 123 and communicates with BS 103. MS 112 is located close to the edge of cell site 123 and moves in the direction of cell site 123, as indicated by the direction arrow proximate MS 112. At some point, as MS 112 moves into cell site 123 and out of cell site 121, a handoff will occur.

As is well known to those skilled in the art, the handoff procedure transfers control of a call from a first cell to a second cell. A handoff may be either a “soft” handoff or a “hard” handoff. In a soft handoff, a connection is made between the mobile station and the base station in the second cell before the existing connection is broken between the mobile station and the base station in the first cell. In a hard handoff, the existing connection between the mobile station and the base station in the first cell is broken before a new connection is made between the mobile station and the base station in the second cell.

As MS 112 moves from cell 121 to cell 123, MS 112 detects the pilot signal from BS 103 and sends a Pilot Strength Measurement Message to BS 101. When the strength of the pilot transmitted by BS 103 and received and reported by MS 112 exceeds a threshold, BS 101 initiates a soft handoff process by signaling the target BS 103 that a handoff is required as described in TIA/EIA IS-95, TIA/EIA IS-2000, or IS-856 (CDMA2000 family of standards).

BS 103 and MS 112 proceed to negotiate establishment of a communications link in the CDMA channel. Following establishment of the communications link between BS 103 and MS 112, MS 112 communicates with both BS 101 and BS 103 in a soft handoff mode. Those acquainted with the art will recognize that soft hand-off improves the performance on both forward (BS to MS) channel and reverse (MS to BS) channel links. When the signal from BS 101 falls below a predetermined signal strength threshold, MS 112 may then drop the link with BS 101 and only receive signals from BS 103. The call is thereby seamlessly transferred from BS 101 to BS 103. The above-described soft handoff assumes the mobile station is in a voice or data call. An idle handoff is the hand-off between cell sites of a mobile station that is communicating in the control or paging channel.

According to the principles of the present invention, the mobile stations operating in wireless network 100 are capable of receiving multicast data transmissions broadcast on shared traffic channels. For example, in an IS-2000 embodiment, each of BS 111-113 may transmit, and each of MS 111-114 may receive, multicast data transmissions in a Forward Packet Data Channel (F-PDCH) or a Forward Supplemental Channel (F-SCH), or both.

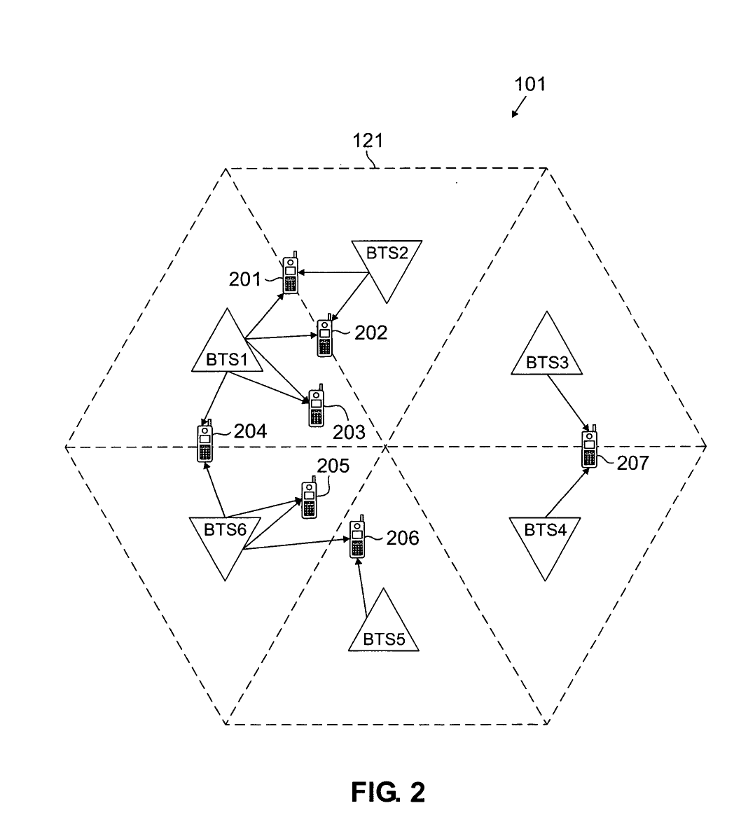

FIG. 2 illustrates multicast data transmissions to a plurality of mobile stations in wireless network 100 according to one embodiment of the present invention. Base station is shown in greater detail. Base station 101 comprises six base transceiver subsystems, labeled BTS1, BTS2, BTS3, BTS4, BTS5 and BTS6. Cell site 121 of base station 101 is shown as a hexagonal shape (rather than a circle, as in FIG. 1) for the purposes of illustration and explanation only. Each base transceiver subsystem (BTS) uses a three-sector antenna, where each of the three sectors (sector a, sector β, sector γ) covers 120 degrees of arc. The coverage area of each BTS is shown as a triangle. The six triangles form the hexagonal coverage area of base station 101.

In FIG. 2, three exemplary multicast data streams (transmissions) are broadcasted. One sector of BTS2 broadcasts a first multicast data transmission to mobile stations 201 and 202. One sector of BTS1 also broadcasts the same first multicast data transmission to mobile stations 201 and 202. Two different sectors of BTS1 broadcast the first multicast data transmission to mobile station 203. Finally, one sector of BTS1 and one sector of BTS6 broadcast the first multicast data transmission to mobile station 204.

Two different sectors of BTS6 broadcast a second multicast data transmission to mobile station 205. One sector of BTS6 broadcasts the second multicast data transmission to mobile station 206. Finally, one sector of BTS5 also broadcasts the second multicast data transmission to mobile station 206.

One sector of BTS3 broadcasts a third multicast data transmission to mobile station 207. Finally, one sector of BTS4 also broadcasts the third multicast data transmission to mobile station 207.

Since BTS1-BTS6 are broadcasting the first, second and third multicast data transmissions using a shared traffic channel, at least some of mobile stations 201-207 receive the multicast data transmissions from more than one BTS. This enhances mobile station reception and is similar to a handoff operation in which a CDMA mobile station receives forward channel signals from two or more base transceiver subsystems.

Each multicast data transmission corresponds to a particular broadcast multicast (BCMC) service provided-by a content provider, such as CNN, HBO, NBC, etc. Each service has multiple BCMCS flows. For example, CNN may provide one flow for visual effects, a different flow for audio effects and a different flow for close-captioning. All of the flows can be either on the same traffic channel or on different traffic channels.

Each traffic channel has different characteristics and different fading impunity. If the user is viewing a particular BCMC service (e.g., HBO), and is not receiving the audio component and/or the video component properly, in accordance with embodiments of the present invention, the user is able to cause the mobile station to send a message to the network informing the network that the audio and/or video component is not being properly received. From this information, the network operator can configure the network to optimize the audio and/or video component.

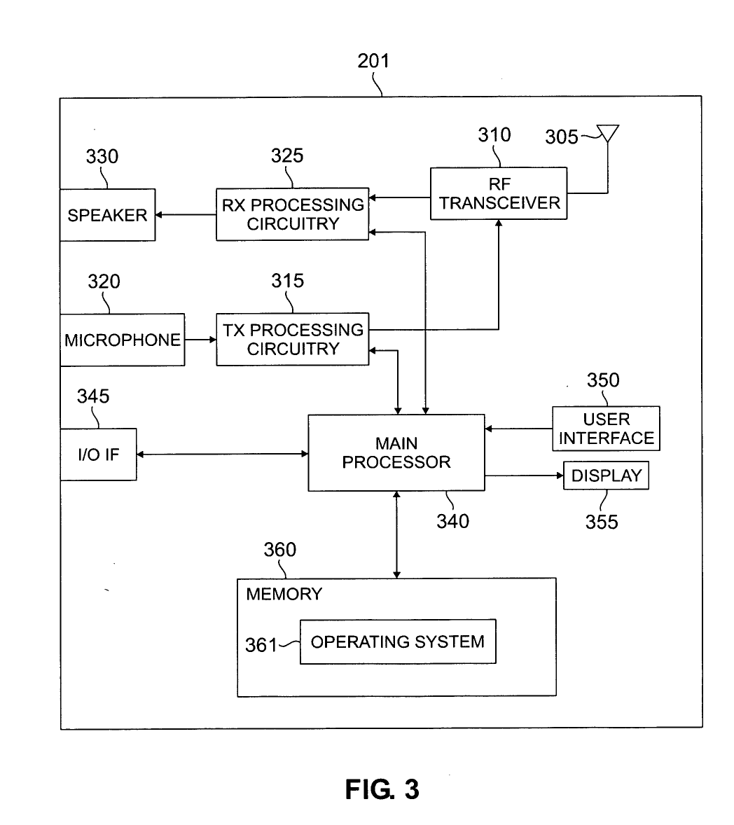

FIG. 3 illustrates wireless mobile station 201 according to an advantageous embodiment of the present invention. Wireless mobile station 201 comprises antenna 305, radio frequency (RF) transceiver 310, transmit (TX) processing circuitry 315, microphone 320, and receive (RX) processing circuitry 325. MS 201 also comprises speaker 330, main processor 340, input/output (I/O) interface (IF) 345, user interface 350, display 355, and memory 360. Memory 360 further comprises basic operating system (OS) program 361.

Radio frequency (RF) transceiver 310 receives from antenna 305 an incoming multicast data transmission (RF signal) broadcasted by a base station of wireless network 100. Radio frequency (RF) transceiver 310 down-converts the incoming signal to produce an intermediate frequency (IF) or a baseband signal. The IF or baseband signal is sent to receiver (RX) processing circuitry 325 that produces a processed baseband signal by filtering, decoding, and/or digitizing the baseband or IF signal. Receiver (RX) processing circuitry 325 transmits the processed baseband signal to speaker 330 (i.e., voice data) or to main processor 340 for further processing (e.g., web browsing).

Transmitter (TX) processing circuitry 315 receives analog or digital voice data from microphone 320 or other outgoing baseband data (e.g., web data, e-mail, interactive video game data) from main processor 340. Transmitter (TX) processing circuitry 315 encodes, multiplexes, and/or digitizes the outgoing baseband data to produce a processed baseband or IF signal. Radio frequency (RF) transceiver 310 receives the outgoing processed baseband or IF signal from transmitter (TX) processing circuitry 315. Radio frequency (RF) transceiver 310 up-converts the baseband or IF signal to a radio frequency (RF) signal that is transmitted via antenna 305.

In an advantageous embodiment of the present invention, main processor 340 is a microprocessor or microcontroller. Memory 360 is coupled to main processor 340. According to an advantageous embodiment of the present invention, part of memory 360 comprises a random access memory (RAM) and another part of memory 360 comprises a Flash memory, which acts as a read-only memory (ROM).

Main processor 340 executes basic operating system (OS) program 361 stored in memory 360 in order to control the overall operation of wireless mobile station 201. In one such operation, main processor 340 controls the reception of forward channel signals and the transmission of reverse channel signals by radio frequency (RF) transceiver 310, receiver (RX) processing circuitry 325, and transmitter (TX) processing circuitry 315, in accordance with well-known principles.

Main processor 340 is capable of executing other processes and programs resident in memory 360. Main processor 340 can move data into or out of memory 360, as required by an executing process. Main processor 340 is also coupled to I/O interface 345. I/O interface 345 provides mobile station 201 with the ability to connect to other devices such as laptop computers and handheld computers. I/O interface 345 is the communication path between these accessories and main controller 340.

Main processor 340 is also coupled to user interface 350 and display unit 355. The user of mobile station 201 uses user interface 350 to enter data into mobile station 201. Display 355 may be a liquid crystal display capable of rendering text and/or at least limited graphics from web sites. Alternate embodiments may use other types of displays.

For example, if the audio and/or video component of a particular BCMC service is not being properly received, the user can access via user interface 350 a menu displayed on display 355 via and enter user input containing a quality of service feature into user interface 350. For example, the quality of service feature can be poor or no audio reception and/or poor or no video reception. In addition, the user input can further contain a continuation indication indicating whether the user wants to continue receiving the particular BCMC service. Main processor 340 converts the user input into the format of a specific signaling message and sends the message to the base station via transceiver 305.

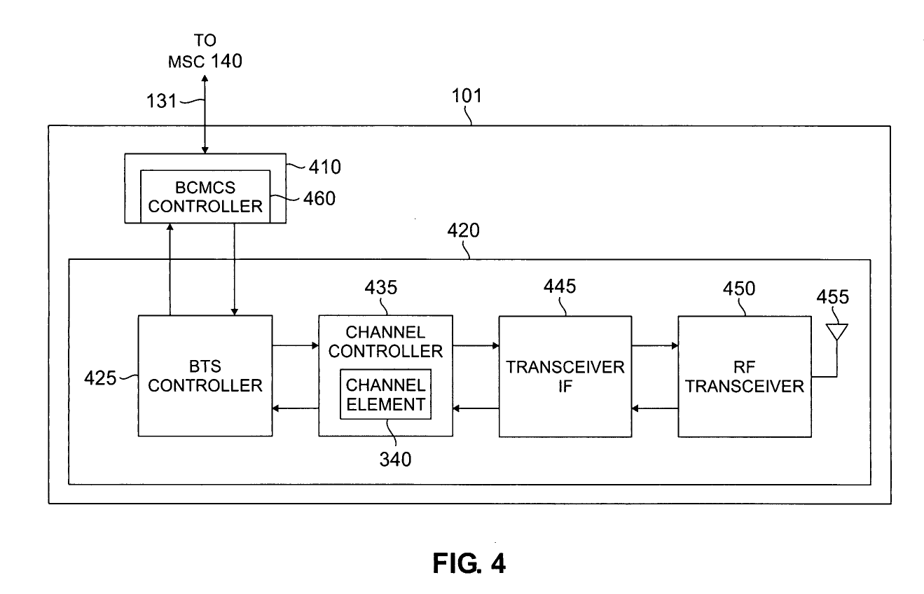

FIG. 4 illustrates exemplary base station 101 in greater detail according to an exemplary embodiment of the present invention. Base station 101 comprises base station controller (BSC) 410 and base transceiver station (BTS) 420. Base station controllers and base transceiver stations were described previously in connection with FIGS. 1 and 2. BSC 410 manages the resources in cell site 121, including BTS 420. BSC 410 includes BCMCS controller 460. BTS 420 comprises BTS controller 425, channel controller 435 (which contains representative channel element 440), transceiver interface (IF) 445, RF transceiver unit 450, antenna array 455, and channel monitor 460.

BTS controller 425 comprises processing circuitry and memory capable of executing an operating program that controls the overall operation of BTS 420 and communicates with BSC 410. Under normal conditions, BTS controller 425 directs the operation of channel controller 435, which contains a number of channel elements, including channel element 440, that perform bi-directional communications in the forward channel and the reverse channel. A “forward” channel refers to outbound signals from the base station to the mobile station and a “reverse” channel refers to inbound signals from the mobile station to the base station. Transceiver IF 445 transfers the bi-directional channel signals between channel controller 440 and RF transceiver unit 450.

Antenna array 455 transmits forward channel signals received from RF transceiver unit 450 to mobile stations in the coverage area of BS 101. Antenna array 455 also sends to transceiver 450 reverse channel signals received from mobile stations in the coverage area of BS 101. In a preferred embodiment of the present invention, antenna array 455 is multi-sector antenna, such as a three-sector antenna in which each antenna sector is responsible for transmitting and receiving in a 1200 arc of coverage area. Additionally, transceiver 450 may contain an antenna selection unit to select among different antennas in antenna array 455 during both transmit and receive operations.

For example, in accordance with embodiments of the present invention, antenna array 455 is capable of receiving a message containing a quality of service feature associated with a particular multicast data transmission from a mobile station and sending the message to transceiver 450. In turn, transceiver forwards the message to BTS controller 425, which passes the message to BSC 410. BCMCS controller 460 in BSC 410 processes the message to determine whether the mobile station wants to continue receiving the multicast data transmission and the particular quality of service feature included in the message. If the mobile station wants to discontinue the BCMC service, BCMC controller 460 updates MSC 140 with the discontinue notification for charging and monitoring purposes.

The quality of service feature provides real-time feedback to BCMCS controller 460 of the quality of the reception of a particular BCMC service at a particular mobile station. From the quality of service feature, BCMCS controller 460 is capable of optimizing the multicast data transmissions broadcast by BTS 420.

For example, in one embodiment, BCMCS controller 460 can request BTS controller 425 to modify (e.g., increase or decrease) the power of the particular BCMCS flow of the BCMC service identified in the message sent from the mobile station. In another embodiment, if audio and video signals are multiplexed onto a single traffic channel, BCMCS controller 460 can request BTS controller 425 to modify the multiplexing of the audio and video signals to improve one or both, depending on the problem identified by the quality of service feature.

In a further embodiment, BCMCS controller 460 can forward the quality of service feature to a content provider of the BCMC service via MSC 140. For example, if the audio and/or video stream reception at BCMCS controller 460 is poor, BCMCS controller 460 can report the problem to the content provider and request the content provider to make the appropriate corrections. In still a further embodiment, BCMCS controller 460 can add error correcting coding (e.g., Reed-Solomon encoding over convolutional/turbo encoding) to assist the mobile station in correctly receiving the multicast data transmission. It should be understood that in other embodiments, BCMCS controller 460 can be programmed to improve, report or optimize the problematic multicast data transmission in other ways.

In one implementation embodiment, the above-described feedback mechanism can be used during deployment of the network. For example, user technicians conducting field testing of a coverage area of BTS 420 can be provided with mobile stations capable of transmitting quality of service messages to BCMCS controller 460. The network operator can use the quality of service information sent from the technician mobile stations in frequency planning, power setting and channel encoding. In another implementation embodiment, the above-described feedback mechanism can be used during live operation of the network. Real-time quality of service updates assist the users in receiving better services and enable the network operators to provide better services to the users. The quality of service updates can be provided periodically by user technicians or in real-time during BCMC service usage by consumer users.

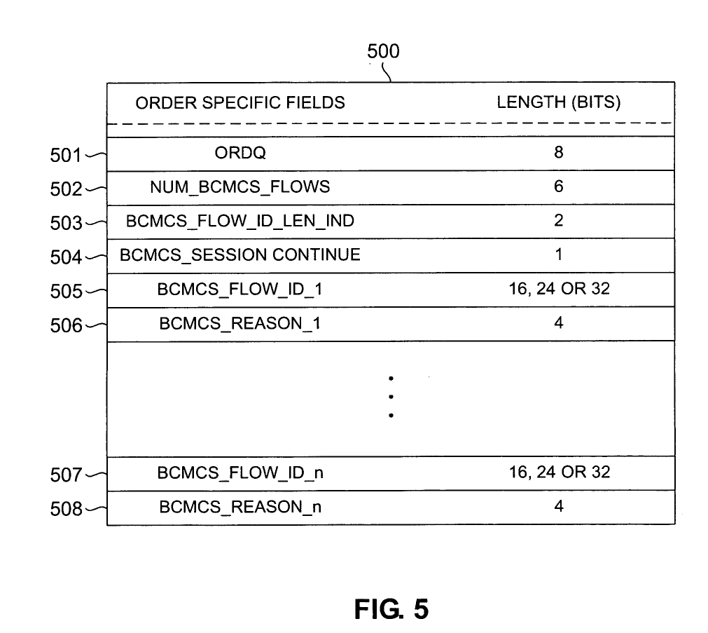

FIG. 5 illustrates an exemplary message 500 according to one embodiment of the present invention. Message 500 shown in FIG. 5 is an order message typically used by mobile stations to request a new traffic channel. Order message 500 has been modified to include a quality of service feature associated with a particular BCMC service. It should be understood that in other embodiments, message 500 can be a special purpose message generated specifically to provide quality of service feature information.

Order message 500 comprises, in addition to other fields known in the art (not shown for simplicity), ORDQ field 501, NUM_BCMCS_FLOWS field 502, BCMCS_FLOW_ID_LEN_IND field 503, BCMCS_SESSION_CONTINUE field 504, BCMCS_FLOW_ID_1 field 505, BCMCS_REASON_1 field 506, BCMCS_FLOW_ID_n field 507 and BCMCS_REASIB_n field 508.

ORDQ field 501 has a length of eight bits and identifies message 500 as an order message. NUM_BCMCS_FLOWS field 502 has a length of six bits and includes the total number of BCMC service flows available. For example, if each BCMC service has three flows and there are three services currently offered in the network, NUM_BCMCS_FLOWS field 502 is set to six. BCMCS_FLOW_ID_LEN_IND field 503 has a length of two bits and is used to indicate the length of the identifier for the particular BCMC service flow for which the mobile station is reporting a problem. BCMCS_SESSION_CONTINUE field 504 has a length of one bit and identifies to the network whether the user still wants to continue with the service or wants to release/reject the service. If BCMCS_SESSION_CONTINUE field 504 is set to Logic 1, the user wants to discontinue the service. If BCMCS_SESSION_CONTINUE field is set to Logic 0, the user wants to continue with the service.

BCMCS_FLOW_ID_1 field 505 has a length of 16, 24 or 32 bits, as indicated in BCMCS_FLOW_ID_LEN_IND field 503. BCMCS_FLOW_ID_1 field 505 includes the identifier for the particular BCMC service (content) flow that is problematic. BCMCS_REASON_1 field 506 has a length of 4 bits and indicated the particular quality of service feature (problem) experienced by the mobile station for the particular BCMC service flow. If there are additional problematic BCMC service flows, order message 500 can include additional BCMCS_FLOW_ID_n fields 507 and BCMCS_REASON_n fields 508.

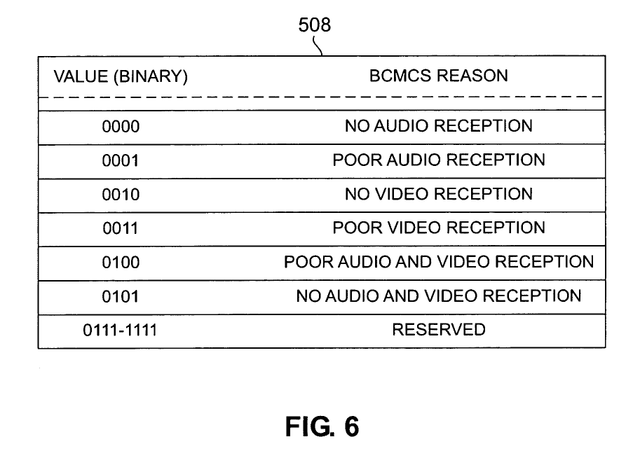

FIG. 6 illustrates exemplary values of the BCMCS_REASON_n field 508 according to one embodiment of the present invention. The BCMCS_REASON_n field 508 is a 4 bit indicator capable of indicating different reasons as to why the user is reporting a problem with the particular BCMC service flow. For example, a value of “0000” can indicate that the user experienced no audio reception of the BCMC service flow, a value of “0001” can indicate that the user experienced poor audio reception of the BCMC service flow, a value of “0010” can indicate that the user experienced no video reception of the BCMC service flow, a value of “0011” can indicate that the user experienced poor video reception of the BCMC service flow, a value of “0101” can indicate that the user experienced poor audio and video reception of the BCMC service flow and a value of “0101” can indicate that the user experienced no audio or video reception of the BCMC service flow. It should be understood that in other embodiments, different values of the BCMCS_REASON_n field 508 can be used to indicate the same or different problems, depending on the network configuration.

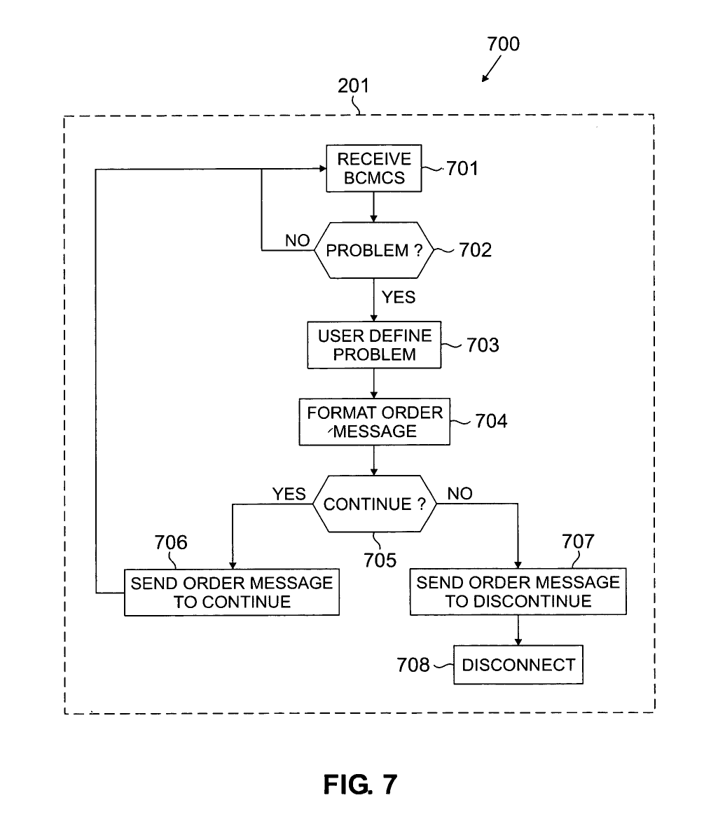

FIG. 7 depicts flow diagram 700, which illustrates a BCMCS feedback operation in the wireless network 100 according to the principles of the present invention. Initially, MS 201 receives a BCMC service from BS 101 (process step 701). If the user experiences any reception problems with the BCMC service (Y branch of decision step 702), the user can access the user interface 350 of MS 201 to enter a quality of service feature defining the problem experienced by the user (process step 703). Thereafter, MS 201 constructs and formats an order message including the quality of service feature identified by the user (process step 704).

If the user has further indicated via user interface 350 that the user wishes to continue receiving the BCMC service (Y branch of decision step 705), MS 201 includes a continue indication in the order message and sends the order message to the base station (process step 706). However, if the user indicated that the user does not want to continue receiving the BCMC service (N branch of decision step 705), MS 201 includes a discontinue indication in the order message and sends the order message to the base station (process step 707). Thereafter, MS 201 disconnects from the BCMC service (process step 708).

Although the present invention has been described with an exemplary embodiment, various changes and modifications may be suggested to one skilled in the art. It is intended that the present invention encompass such changes and modifications as fall within the scope of the appended claims.

1. For use in a wireless network, a mobile station capable of receiving multicast data transmissions broadcast in a coverage area of a base station, said mobile station comprising:
a user interface capable of receiving input from a user of said mobile station, said input indicating a quality of service feature associated with said multicast data transmissions;
a processor capable of receiving said input from said user interface and constructing a message including said quality of service feature; and
a transceiver capable of receiving said multicast data transmissions and transmitting said message to said base station.

2. The mobile station as set forth in claim 1 wherein said quality of service feature is selected from the group consisting of: no audio reception, poor audio reception, no video reception, poor video reception, no audio or video reception, and poor audio and video reception.

3. The mobile station as set forth in claim 1 wherein said message is a special purpose message.

4. The mobile station as set forth in claim 1 wherein said message is an order message.

5. The mobile station as set forth in claim 4 wherein said quality of service feature is included in a broadcast multicast service reason field of said order message.

6. The mobile station as set forth in claim 5 wherein said order message further comprises a broadcast multicast flow field identifying a particular content flow of said multicast data transmissions.

7. The mobile station as set forth in claim 6 wherein said order message further comprises a broadcast multicast service session continue field indicating whether said mobile station wants to continue to receive said particular content flow.

8. For use in a wireless network, a base station capable of broadcasting multicast data transmissions to a plurality of mobile stations, said base station comprising:
a transceiver capable of broadcasting said multicast data transmissions and receiving a message from a select one of said plurality of mobile stations, said message including a quality of service feature associated with said multicast data transmissions; and
a controller capable of optimizing said multicast data transmissions based on said quality of service feature.

9. The base station as set forth in claim 8 wherein said quality of service feature is selected from the group consisting of: no audio reception, poor audio reception, no video reception, poor video reception, no audio or video reception and poor audio and video reception.

10. The base station as set forth in claim 8 wherein said message is a special purpose message.

11. The base station as set forth in claim 8 wherein said message is an order message.

12. The base station as set forth in claim 11 wherein said quality of service feature is included in a broadcast multicast service reason field of said order message.

13. The base station as set forth in claim 12 wherein said order message further comprises a broadcast multicast flow field identifying a particular content flow of said multicast data transmissions.

14. The base station as set forth in claim 13 wherein said order message further comprises a broadcast multicast service session continue field indicating whether said select mobile station wants to continue to receive said particular content flow.

15. The base station as set forth in claim 8, wherein said message is received during field testing of said base station.

16. The base station as set forth in claim 8, wherein said controller is further capable of modifying the power of said multicast data transmissions to optimize said multicast data transmissions.

17. The base station as set forth in claim 8, wherein said controller is further capable of modifying the multiplexing of said multicast data transmissions to optimize said multicast data transmissions.

18. The base station as set forth in claim 8, wherein said controller is further capable of forwarding said quality of service feature to a content provider of said multicast data transmissions to optimize said multicast data transmissions.

19. The base station as set forth in claim 8, wherein said controller is further capable of adding error correcting coding to said multicast data transmissions to optimize said multicast data transmissions.

20. A message transmitted from a mobile station to a base station in a wireless network providing broadcast multicast services, wherein said message includes a quality of service feature associated with multicast data transmissions broadcast from said base station to a plurality of mobile stations.

21. The message as set forth in claim 20 wherein said message is a special purpose message.

22. The message as set forth in claim 20 wherein said message is an order message.

23. The message as set forth claim 22, wherein said quality of service feature is included in a broadcast multicast service reason field of said order message.

24. The message as set forth in claim 23 wherein said order message further comprises a broadcast multicast flow field identifying a particular content flow of said multicast data transmissions.

25. The message as set forth in claim 24 wherein said order message further comprises a broadcast multicast service session continue field indicating whether said select mobile station wants to continue to receive said particular content flow.

26. A method of deploying broadcast multicast services in a wireless network comprising a base station capable of broadcasting multicast data transmissions to a plurality of mobile stations in a coverage area of the base station, the method comprising the steps of:
receiving input from a user of a select one of the mobile stations, the input indicating a quality of service feature associated with the multicast data transmissions;
constructing a message including the quality of service feature; and
transmitting the message from the select mobile station to the base station.

27. The method as set forth in claim 26 further comprising the step of identifying a particular content flow of said multicast data transmissions.

28. The method as set forth in claim 27 further comprising the step of determining whether said mobile station wants to continue to receive said particular content flow.

29. The method as set forth in claim 26 further comprising the step of receiving said message during field testing of said base station.

30. The method as set forth in claim 26, further comprising the step of modifying the power of said multicast data transmissions to optimize said multicast data transmissions.

31. The method as set forth in claim 26, further comprising the step of modifying the multiplexing of said multicast data transmissions to optimize said multicast data transmissions.

32. The method as set forth in claim 26, further comprising the step of forwarding said quality of service feature from said base station to a content provider of said multicast data transmissions to optimize said multicast data transmissions.

33. The method as set forth in claim 26, further comprising the step of adding error correcting coding to said multicast data transmissions to optimize said multicast data transmissions.
